(19) United States
(12) Patent Application Publication
(10) Pub. No.: US 2023/0314010 A1
(43) Pub. Date: Oct. 5, 2023

(54) WATER HEATING DEVICE

(71) Applicant: RINNAI CORPORATION, Nagoya-shi (JP)

(72) Inventor: Tomohiro Uchida, Nagoya-shi (JP)

(21) Appl. No.: 18/180,154

(22) Filed: Mar. 8, 2023

(30) Foreign Application Priority Data
Apr. 1, 2022 (JP) 2022-062180

(51) Int. Cl. F24D 3/10

(52) U.S. Cl. CPC F24D 3/1091; F24D 2220/0221; F24H 1/523

(57) ABSTRACT

The present invention provides a water heating device capable of shortening a flow passage that mixes hot water and cold water and saving space in the device. In a flow path cross section of circular orthogonal to the central axis of the flow path, the flow inlet has an outer wall extending from the inner peripheral surface of the flow path in a direction of a tangent of the inner peripheral surface, and the central axis of the flow inlet is disposed closer to the inner peripheral surface of the flow path connected to the outer wall with respect to the central axis of the flow path.

### BACKGROUND OF THE INVENTION

### Field of the Invention

The present invention relates to a water heating device for mixing hot water and cold water and supplying the mixture.

### DESCRIPTION OF THE RELATED ART

A conventional water heating device includes a water supply pipe for supplying cold water from a water supply source to a heat exchanger and a hot-water discharge pipe for discharging hot water generated by the heat exchanger. A bypass pipe pulled out from the water supply pipe bypasses the heat exchanger and is connected to the hot-water discharge pipe, and cold water from the bypass pipe is mixed with hot water flowing through the hot-water discharge pipe to generate hot water at a set temperature (e.g., Japanese Patent Application Laid-Open No. 2010-38505).

In the conventional water heating device, hot water and cold water are mixed by a turbulent flow in a flow passage after the mixing of the hot water and the cold water at the confluence of the hot-water discharge pipe and the bypass pipe. However, in this case, evenly mixing hot water and cold water requires the lengthening of the flow passage after the mixing of the hot water and the cold water at the confluence, and this has caused a problem of an increase in the loss of space in the device with the lengthening of the flow passage.

### SUMMARY OF THE INVENTION

The present invention has been made in view of the above circumstances, and an object of the present invention is to provide a water heating device capable of shortening a flow passage that mixes hot water and cold water and saving space in the device.

A water heating device according to the present invention is a water heating device for mixing hot water and cold water and supplying the mixture, the water heating device including: a hot-water flow inlet serving as a flow inlet through which the hot water flows in; a cold-water flow inlet serving as a flow inlet through which the cold water flows in; a flow path through which a hot water mixture, obtained by mixing of the hot water and the cold water, flows; and a flow outlet through which the hot water mixture flows out. An inner peripheral surface of the flow path is formed in a cylindrical shape, the hot-water flow inlet and the cold-water flow inlet are formed on one end side of the flow path, and the flow outlet is formed on the other end side of the flow path, and a flow inlet that is at least one of the hot-water flow inlet and the cold-water flow inlet is opened on the inner peripheral surface of the flow path, and in a flow path cross section of circular orthogonal to a central axis of the flow path, the flow inlet has an outer wall extending from the inner peripheral surface of the flow path in a direction of a tangent of the inner peripheral surface, and a central axis of the flow inlet is disposed closer to the inner peripheral surface of the flow path connected to the outer wall with respect to the central axis of the flow path.

With the above configuration, the hot water or the cold water flowing into the flow path from at least one of the hot-water flow inlet and the cold-water flow inlet opened on the inner peripheral surface of the flow path flows in a swirling manner in the circumferential direction along the cylindrical inner peripheral surface of the flow path. As a result, in the flow path, the hot water and the cold water are mixed by a swirling flow that swirls and become a hot water mixture. Further, the hot water mixture of the hot water and the cold water in the flow path flows in a swirling manner in the circumferential direction through the flow path, whereby the moving distance (mixing distance) can be made longer than a case where the hot water mixture flows in the axial direction of the flow path. Thus, a flow length for the hot water mixture is substantially increased in the flow path, and the hot water and the cold water can be mixed evenly. As described above, it is possible to reduce the length of the flow path while ensuring high performance in mixing hot water and cold water, and it is possible to achieve space-saving in the device. In addition, there is no need to add a part that enhances the mixing of hot water and cold water to the flow path, so that the configuration does not become complex, and the cost does not increase.

The water heating device can be configured such that each of the hot-water flow inlet and the cold-water flow inlet has the outer wall and is opened on the inner peripheral surface of the flow path, and a positional relationship between the hot-water flow inlet and the cold-water flow inlet is that the hot-water flow inlet and the cold-water flow inlet are disposed at different positions by a predetermined angle in the circumferential direction of the inner peripheral surface of the flow path or at the same position in the circumferential direction.

With the above configuration, the hot water and the cold water flowing into the flow path from the hot-water flow inlet and the cold-water flow inlet opened on the inner peripheral surface of the flow path flow in a swirling manner in the same circumferential direction along the cylindrical inner peripheral surface of the flow path. Thereby, when the hot water and the cold water flow into the flow path, the swirling flow of the hot water mixture obtained by mixing of the hot water and the cold water is formed favorably and reliably. It is thus possible to mix the hot water and the cold water more evenly in the flow path.

The water heating device can be configured such that a total length of the inner diameter of the hot-water flow inlet and the inner diameter of the cold-water flow inlet is set to be equal to or less than the inner diameter of the flow path. It is assumed here that the inner diameter of the hot-water flow inlet and the inner diameter of the cold-water flow inlet are the inner diameters at positions closest to the inner peripheral surface of the flow path in the cross-section orthogonal to the axes of the respective flow inlets.

With the above configuration, in the flow path, it is possible to prevent the hot water flowing in from the hot-water flow inlet and the cold water flowing in from the cold-water flow inlet from facing each other and colliding with each other. For example, in a case where the hot-water flow inlet and the cold-water flow inlet are disposed at positions different from each other by 180 degrees in the circumferential direction of the inner peripheral surface of the flow path, the projection surfaces of the hot-water flow inlet and the cold-water flow inlet in the flow path do not overlap each other, and the hot water and the cold water do not collide with each other as counter flows when flowing into the flow path. It is thus possible to form a swirling flow in which hot water and cold water smoothly swirl along the circumferential direction of the inner peripheral surface of the flow path. Hence the flow of the hot water mixture of the hot water and the cold water in the flow path is less likely to be disturbed, and a good swirling flow can be generated, enabling the hot water and the cold water to be mixed more evenly in the flow path.

The water heating device can be configured such that the hot-water flow inlet and/or the cold-water flow inlet are disposed at angles where the central axes of the flow inlet is substantially orthogonal to the central axis of the flow path.

With the above configuration, the hot water and/or the cold water flow into the flow path substantially perpendicularly to the length direction of the flow path, so that the number of swirls of the swirling flow of the hot water mixture can be ensured for a predetermined length of the flow path, and the flow length for the hot water mixture can be made as long as possible. It is thus possible to mix the hot water and the cold water more evenly in the flow path of the predetermined length.

### BRIEF DESCRIPTION OF THE DRAWINGS

FIG. 1 is a configuration diagram showing an overall configuration of a water heating device according to the present embodiment;

FIG. 2A is a cross-sectional view along a direction perpendicular to the axis of the mixer;

FIG. 2B is a cross-sectional view showing a state where a hot water and a cold water swirls in the flow path of the mixer;

FIG. 3 is a side view showing the side surface of the mixer;

FIG. 4 is a schematic view showing a state where a hot water mixture of hot water and cold water swirls and flows in the flow path of the mixer; and

FIGS. 5A-5I are a schematic diagram showing modifications of the mixer.

### DETAILED DESCRIPTION OF THE PREFERRED EMBODIMENT

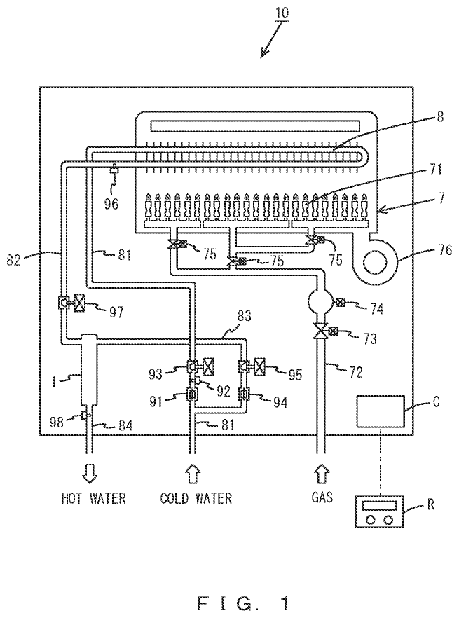

The water heating device according to the embodiment mixes hot water heated by a heat exchanger and cold water from a water supply source with a mixer to generate hot water at a set temperature. As the main configuration, as shown in FIG. 1, a water heating device 10 includes a combustion chamber 7, a heat exchanger 8, pipes, and a mixer 1.

The combustion chamber 7 includes a burner 71, and combustion exhaust is generated by the burner 71. The combustion chamber 7 is provided with a gas pipe 72 for supplying fuel gas to the burner 71. The gas pipe 72 is provided with a main gas solenoid valve 73 for opening and closing the gas pipe 72, a gas proportional valve 74 for adjusting the amount of fuel gas supplied, and a switching gas solenoid valve 75 for switching the number of burners 71 to perform burning. A fan 76 for supplying combustion air to the burner 71 is disposed at the bottom of the combustion chamber 7.

The heat exchanger 8 heats cold water from a water supply source, such as a water tap, to generate hot water through the circulation of the combustion exhaust from the combustion chamber 7. A water supply pipe 81 for supplying the cold water from the water supply source, such as the water tap, to the heat exchanger 8 is connected to the upstream end of the heat exchanger 8, and a hot-water discharge pipe 82 for discharging the hot water heated by the heat exchanger 8 is connected to the downstream end of the heat exchanger 8. The water supply pipe 81 is provided with a bypass pipe 83 branched from the water supply pipe 81. The downstream end of the hot-water discharge pipe 82 and the downstream end of the bypass pipe 83 are connected to the mixer 1. Also, a hot-water supply pipe 84 is connected to the mixer 1. Therefore, the cold water flowing through the water supply pipe 81 is partly diverted to the bypass pipe 83, and the rest of the cold water flows into the heat exchanger 8, is heated to become hot water, and flows out to the hot-water discharge pipe 82. In the mixer 1, the hot water flowing through the hot-water discharge pipe 82 becomes a hot water mixture (hot water) mixed with the cold water flowing in from the bypass pipe 83 and flows out to the hot-water supply pipe 84. The hot water flowing out to the hot-water supply pipe 84 is supplied to a hot-water supply terminal (not shown), such as a faucet or a shower, provided downstream of the hot-water supply pipe 84.

In the water supply pipe 81, the following are provided at positions downstream of the branch of the bypass pipe 83: a water amount sensor 91 for detecting the amount of cold water flowing into the heat exchanger 8, a water supply temperature sensor 92 for detecting the temperature of the cold water flowing through the water supply pipe 81, and a can body water amount adjustment valve 93 for adjusting the amount of cold water flowing into the heat exchanger 8. The bypass pipe 83 is provided with a bypass water amount sensor 94 for detecting the amount of cold water flowing through the bypass pipe 83 and a bypass water amount control valve 95 for controlling the amount of cold water flowing through the bypass pipe 83. In the hot-water discharge pipe 82, a can body temperature sensor 96 for detecting the temperature of the hot water flowing out of the heat exchanger 8 (heat exchanger temperature) is provided near the outlet of the heat exchanger 8, and a hot-water amount control valve 97 for controlling the flow rate of the hot water flowing through the hot-water discharge pipe 82 is provided near the mixer 1. The hot-water supply pipe 84 is provided with a hot-water discharge temperature sensor 98 for detecting the temperature of the hot water flowing through the hot-water supply pipe 84 to make the hot water at a set temperature.

The water heating device 10 includes a controller C communicably connected to a remote controller R that performs a setting of a hot-water supply temperature and the like. The controller C controls valves 73, 74, 75, 93, 95, 97 and the fan 76 on the basis of detection signals obtained from the sensors 91, 92, 96, 98 and executes hot-water supply control so that hot water at a set temperature set by the remote controller R is supplied to the hot-water supply terminal.

Next, the mixer 1 will be described.

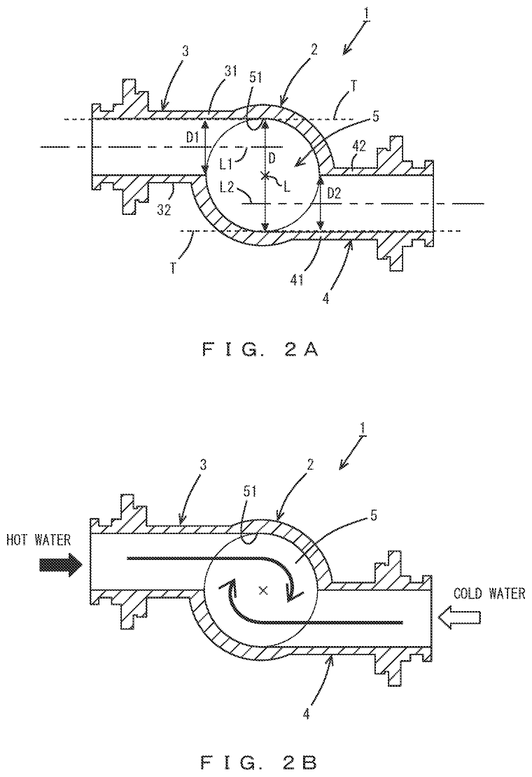

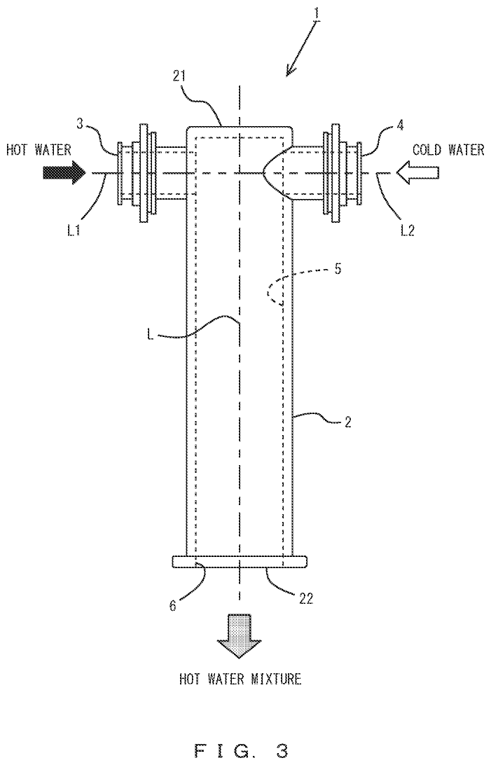

The mixer 1 is configured such that the hot water flowing in from the hot-water discharge pipe 82 and the cold water flowing in from the bypass pipe 83 are mixed by a swirling flow. The mixer 1 is made of resin and can be manufactured at low cost. Note that the mixer 1 may be made of metal. As shown in FIGS. 2A, 2B, and 3, the mixer 1 includes: a pipe body 2 having a cylindrical shape with a hollow interior; a hot-water flow inlet 3 serving as a flow inlet through which hot water heated by the heat exchanger 8 flows in; a cold-water flow inlet 4 serving as a flow inlet through which cold water from a water supply source flows in; a flow path 5 through which a hot water mixture, obtained by mixing the hot water flowing from the hot-water flow inlet 3 and the cold water flowing from the cold-water flow inlet 4, flows; and a flow outlet 6 through which the hot water mixture having flowed through the flow path 5 flows out.

The inside of the pipe body 2 has an internal space with an inner peripheral surface 51 formed in a cylindrical shape, and the internal space constitutes the flow path 5. In the water heating device 10, the mixer 1 is installed vertically, in which the length direction (also the length direction of the pipe body 2) being the direction of an axis L of the flow path 5 is the vertical direction. The upper side is one end side of the length direction of the flow path 5 and the lower side is the other end side of the length direction of the flow path 5. In the water heating device 10, the mixer 1 may be installed sideways, in which the length direction of the flow path 5 is the left-right direction (horizontal direction). In the sideways installation, one of the left and right ends of the flow path 5 is one end side, and the other of the left and right ends of the flow path 5 is the other end side.

The hot-water flow inlet 3 and the cold-water flow inlet 4 are formed to protrude in a cylindrical shape from the side wall of the pipe body 2 on the one end side of the flow path 5 and are opened on the inner peripheral surface 51 of the flow path 5 to communicate with the flow path 5. An upper end surface 21 of the pipe body 2, which is the end surface on the one end side of the flow path 5, is closed. The downstream end of the hot-water discharge pipe 82 is connected to the hot-water flow inlet 3, and the hot water heated by the heat exchanger 8 flows in through the hot-water discharge pipe 82. The downstream end of the bypass pipe 83 is connected to the cold-water flow inlet 4, and the cold water from the water supply source flows in through the bypass pipe 83. The hot water flowing into the flow path 5 from the hot-water flow inlet 3 and the cold water flowing into the flow path 5 from the cold-water flow inlet 4 are mixed while swirling in the circumferential direction along the cylindrical inner peripheral surface 51 of the flow path 5 to become a hot water mixture, flowing through the flow path 5. The flow outlet 6 is formed by a circular opening end where the flow path 5 is opened at the lower end surface 22 of the pipe body 2, which is the end surface on the other end side of the flow path 5. Therefore, in the flow path 5, the upper end side that is the one end side provided with the hot-water flow inlet 3 and the cold-water flow inlet 4 is the upstream side, and the lower end side that is the other end side provided with the flow outlet 6 is the downstream side. The hot water mixture, obtained by mixing of the hot water and the cold water, flows through the flow path 5. The hot water mixture of the hot water and the cold water having flowed through the flow path 5 flows out from the flow outlet 6. The flow outlet 6 is connected to the hot-water supply pipe 84, and the hot water of the hot water mixture flowing out from the flow outlet 6 is discharged to the hot-water supply pipe 84.

In a flow path cross section of circular orthogonal to the central axis L of the flow path 5, the hot-water flow inlet 3 and the cold-water flow inlet 4 have outer walls 31, 41 extending in the direction of a tangent T of the inner peripheral surface 51 of the flow path 5 and inner walls 32, 42 extending in parallel with the outer walls 31, 41 at positions facing the outer walls 31, 41. The hot-water flow inlet 3 and the cold-water flow inlet 4 are formed in a cylindrical shape having smaller diameters (D1, D2) than an inner diameter D of the flow path 5. Note that the inner walls 32, 42 are extended to intersect the inner peripheral surface 51 of the flow path 5. The hot-water flow inlet 3 and the cold-water flow inlet 4 are configured such that their respective central axes L1, L2 are disposed closer to the inner peripheral surface 51 of the flow path 5, to which the outer walls 31, 41 are connected, with respect to the central axis L of the flow path 5. That is, the hot-water flow inlet 3 and the cold-water flow inlet 4 are extended in the direction of the tangent T from the inner peripheral surface 51 of the flow path 5 and are disposed closer to the inner peripheral surface 51 of the flow path 5 from the central axis L of the flow path 5.

The hot-water flow inlet 3 and the cold-water flow inlet 4 are disposed at the same position in the length direction of the flow path 5. That is, the hot-water flow inlet 3 and the cold-water flow inlet 4 are provided at the same height position on the side wall of the pipe body 2. The hot-water flow inlet 3 and the cold-water flow inlet 4 are disposed at angles where their respective central axes L1, L2 are substantially orthogonal to the central axis L of the flow path 5. That is, the hot-water flow inlet 3 and the cold-water flow inlet 4 are each extended at an angle of approximately 90 degrees with respect to the straight line (L) in the length direction of the flow path in the side view of the mixer 1. Therefore, since the length direction of the flow path 5 is set to be the vertical direction, the hot water from the hot-water flow inlet 3 and the cold water from the cold-water flow inlet 4 flow into the flow path 5 from the substantially horizontal direction, and the hot water mixture, obtained by mixing of the hot water and the cold water, flows down the flow path 5.

The hot-water flow inlet 3 and the cold-water flow inlet 4 are provided at positions different from each other by 180 degrees in the circumferential direction on the cylindrical inner peripheral surface 51 of the flow path 5. That is, the hot-water flow inlet 3 and the cold-water flow inlet 4 are disposed at positions rotationally symmetric with respect to the central axis L of the flow path 5 when the pipe body 2 is viewed from one end side. The inner diameter D1 of the hot-water flow inlet 3 and the inner diameter D2 of the cold-water flow inlet 4 are formed to have substantially the same diameter size as ½ (radius) of the inner diameter D of the flow path 5. It is assumed here that the inner diameter D1 of the hot-water flow inlet 3 and the inner diameter D2 of the cold-water flow inlet 4 are inner diameters at positions closest to the inner peripheral surface 51 of the flow path 5 in the cross-section orthogonal to the axes L1, L2 of the flow inlets 3, 4. Hence the hot-water flow inlet 3 and the cold-water flow inlet 4 are disposed to be shifted in the diameter (D) direction of the flow path 5 so that the projection surfaces with respect to the flow path 5 do not overlap each other.

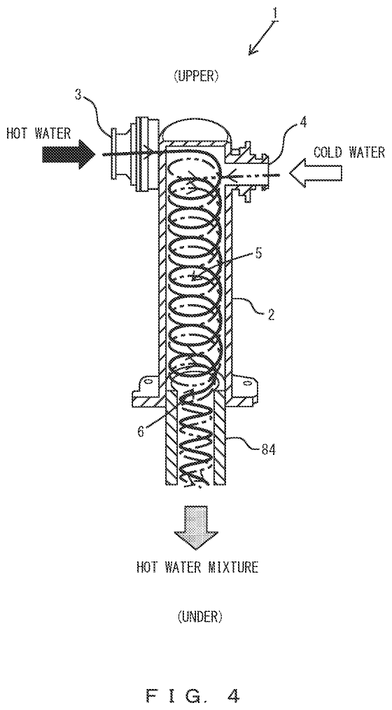

According to the mixer 1 having the above configuration, as shown in FIGS. 2B and 4, the hot water and the cold water flowing into the flow path 5 from the hot-water flow inlet 3 and the cold-water flow inlet 4 opened on the inner peripheral surface 51 of the flow path flow in a swirling manner in the circumferential direction along the cylindrical inner peripheral surface 51 of the flow path 5, flowing down the flow path 5. In this case, the hot-water flow inlet 3 and the cold-water flow inlet 4 are provided at positions that are rotationally symmetric with respect to the central axis L of the flow path 5 and are different from each other by 180 degrees in the circumferential direction of the inner peripheral surface 51 of the flow path 5, so that the hot water and the cold water flowing into the flow path 5 flow in a swirling manner in the same circumferentially rotating direction along the inner peripheral surface 51 of the flow path 5. As a result, in the flow path 5, the hot water and the cold water are mixed by a swirling flow that swirls and become a hot water mixture. Further, the hot water mixture of the hot water and the cold water in the flow path 5 flows in a swirling manner in the circumferential direction through the flow path 5, whereby the moving distance (mixing distance) becomes longer than a case where the hot water mixture flows in the direction of the axis L (length direction) of the flow path 5. Thus, a flow length for the hot water mixture is substantially increased in the flow path 5, and the hot water and the cold water can be mixed evenly.

The inner diameter D1 of the hot-water flow inlet 3 and the inner diameter D2 of the cold-water flow inlet 4 are formed to have substantially the same diameter size as the radius (D/2) of the flow path cross section of the flow path 5, making it possible to prevent the projection surfaces of the hot-water flow inlet 3 and the cold-water flow inlet 4 in the flow path 5 from overlapping each other. Thus, in the flow path 5, it is possible to prevent the hot water flowing in from the hot-water flow inlet 3 and the cold water flowing in from the cold-water flow inlet 4 from facing each other and colliding with each other, and it is possible to form a swirling flow in which the hot water and the cold water smoothly swirl along the circumferential direction of the inner peripheral surface 51 of the flow path 5. Therefore, the flow of the hot water mixture of the hot water and the cold water in the flow path 5 is less likely to be disturbed, and a good swirling flow can be generated, enabling the hot water and the cold water to be mixed evenly.

Here, if the central axes L1, L2 of the hot-water flow inlet 3 and the cold-water flow inlet 4 are inclined in the direction of the flow outlet 6 of the flow path 5 with respect to the central axis L of the flow path 5, components going toward the flow outlet 6 of the flow path increase in the swirling flow of the hot water mixture formed in the flow path 5. Therefore, the number of swirls of the swirling flow of the hot water mixture in the flow path 5 may decrease for a predetermined length of the flow path 5, and it may not be possible to increase the flow length for the hot water mixture. Conversely, if the central axes L1, L2 of the hot-water flow inlet 3 and the cold-water flow inlet 4 are inclined in the direction opposite to the direction of the flow outlet 6 of the flow path 5 (the closed one end 21 side of the flow path 5) with respect to the central axis L of the flow path 5, the swirling flow of the hot water mixture is easily disturbed when the flow of the hot water mixture of the hot water and the cold water turns back at the end surface 21 on the one end side of the flow path 5, and as a result, it may not be possible to increase the flow length for the hot water mixture.

However, in the present embodiment, the hot-water flow inlet 3 and the cold-water flow inlet 4 are disposed at angles where their respective central axes L1, L2 are substantially orthogonal to the central axis L of the flow path 5, so that for a predetermined length of the flow path 5, the number of swirls of the swirling flow of the hot water mixture is prevented from being reduced, and the swirling flow is prevented from being disturbed. Hence the number of swirls of the swirling flow of the hot water mixture in the predetermined length of the flow path 5 can be ensured to be large, and the flow length for the spiral hot water mixture can be made as long as possible. It is thus possible to mix the hot water and the cold water more evenly in the flow path 5 of the predetermined length.

As described above, according to the mixer 1 of the present embodiment, it is possible to reduce the length of the flow path 5 in the axial direction, that is, the entire length of the mixer 1, while ensuring high performance in mixing hot water and cold water, and it is possible to achieve space-saving in the water heating device 10. In addition, the mixer 1 according to the present embodiment does not require the addition of a part that enhances the mixing of the hot water and the cold water, so that the configuration does not become complex, and the cost does not increase.

Note that the present invention is not limited to the above embodiment, and various modifications can be made within the scope of the claims. For example, various modifications can be made as long as the flow path 5 provided with the hot-water flow inlet 3, the cold-water flow inlet 4, and the flow outlet 6 is configured to generate a swirling flow of a hot water mixture obtained by mixing of hot water and cold water. Configurations of the following modifications alone or in combination are included in the present invention.

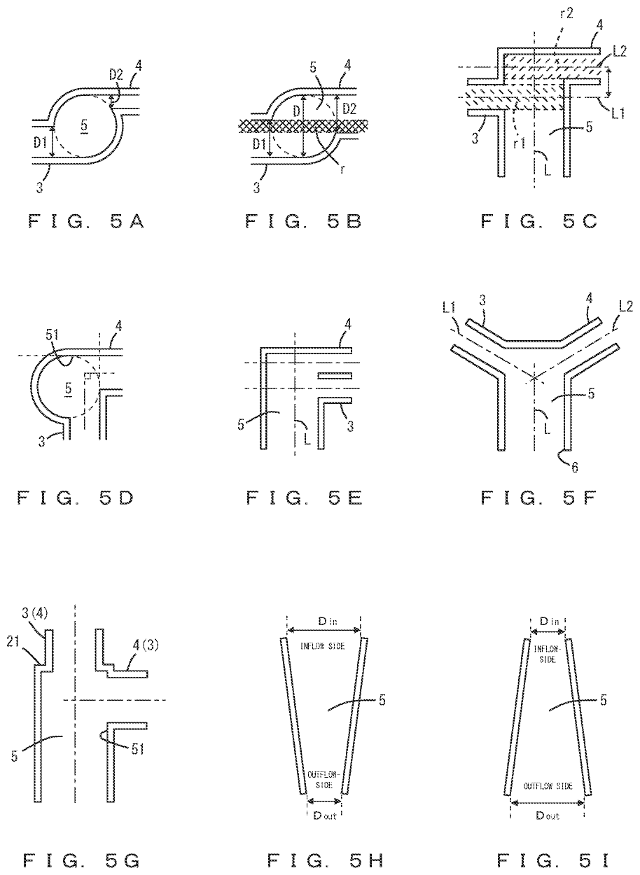

(1) FIG. 5A is a schematic cross-sectional view along a direction perpendicular to the axis of the mixer 1. As shown in FIG. 5A, the hot-water flow inlet 3 and the cold-water flow inlet 4 may be configured to have inner diameters D1, D2 different from each other.

(2) FIG. 5B is a schematic cross-sectional view along a direction perpendicular to the axis of the mixer 1. As shown in FIG. 5B, the hot-water flow inlet 3 and the cold-water flow inlet 4 may be configured to have a region r in which projection surfaces partially overlap each other in the flow path 5. In this case, the degree of overlap between the hot-water flow inlet 3 and the cold-water flow inlet 4 can be arbitrarily set within a range in which a swirling flow of hot water and cold water is generated in the flow path 5, and a specific degree of overlap can be determined appropriately.

(3) As shown in FIG. 5B, it may be configured such that a total length of the inner diameter D1 of the hot-water flow inlet 3 and the inner diameter D2 of the cold-water flow inlet 4 is larger than the inner diameter D of the flow path 5 (D1+D2>D). However, the inner diameters D1, D2 of the hot-water flow inlet 3 and the cold-water flow inlet 4 are smaller than the inner diameter D of the flow path 5.

(4) FIG. 5C is a schematic cross-sectional view along the axial direction of the mixer 1. For example, as shown in FIG. 5C, the hot-water flow inlet 3 and the cold-water flow inlet 4 may be configured to be provided at positions where their respective central axes L1, L2 are shifted in the direction of the axis (L) of the flow path 5. That is, when the direction of the axis (L) of the flow path 5 is set to be the vertical direction, it may be configured such that a region r1 of the projection surface of the hot-water flow inlet 3 and a region r2 of the projection surface of the cold-water flow inlet 4 may not overlap vertically in a side view of the flow path 5 (FIG. 5C), or it may be configured such that the projection surface regions r1, r2 may partially overlap vertically (not shown).

(5) FIG. 5D is a schematic cross-sectional view along a direction perpendicular to the axis of the mixer 1. As shown in FIG. 5D, the hot-water flow inlet 3 and the cold-water flow inlet 4 may be configured to be provided at positions different from each other by 90 degrees in the circumferential direction on the inner peripheral surface 51 of the flow path 5 or to be provided at positions different from each other by another arbitrary angle.

(6) FIG. 5E is a schematic cross-sectional view along the axial direction of the mixer 1. As shown in FIG. 5E, when the hot-water flow inlet 3 and the cold-water flow inlet 4 are provided at positions shifted in the direction of the axis (L) of the flow path 5, the hot-water flow inlet 3 and the cold-water flow inlet 4 may be configured to be aligned vertically at the same position in the circumferential direction of the inner peripheral surface 51 of the flow path 5.

(7) FIG. 5F is a schematic cross-sectional view along the axial direction of the mixer 1. As shown in FIG. 5F, the hot-water flow inlet 3 and the cold-water flow inlet 4 may be configured such that their respective central axes L1, L2 are inclined with respect to the central axis L of the flow path 5 in the direction of the flow outlet 6 of the flow path 5, or may be configured such that the central axes L1, L2 are inclined in the direction opposite to the direction of the flow outlet 6 of the flow path 5 (not shown).

(8) FIG. 5G is a schematic cross-sectional view along the axial direction of the mixer 1. As shown in FIG. 5G, one of the hot-water flow inlet 3 and the cold-water flow inlet 4 may be opened on the inner peripheral surface 51 of the flow path 5, and the other may be opened on the one end of the flow path 5 (upper end surface 21).

(9) FIGS. 5H and 5I are a schematic cross-sectional view along the axial direction of the mixer 1. As shown in FIGS. 5H and 5I, the flow path 5 may be formed in a conical shape where an inner diameter Din on the inflow side and an inner diameter Dout on the outflow side of the hot water and the cold water are different from each other.

Further, the present invention may be a water heating device in which only the mixer (1) is configured separately, and hot water supplied from an external heat source and cold water supplied from a water supply source are mixed by the mixer (1).

What is claimed is:

1. A water heating device for mixing hot water and cold water and supplying the mixture, the water heating device comprising:
a hot-water flow inlet serving as a flow inlet through which the hot water flows in;
a cold-water flow inlet serving as a flow inlet through which the cold water flows in;
a flow path through which a hot water mixture, obtained by mixing of the hot water and the cold water, flows; and
a flow outlet through which the hot water mixture flows out,
wherein
an inner peripheral surface of the flow path is formed in a cylindrical shape, the hot-water flow inlet and the cold-water flow inlet are formed on one end side of the flow path, and the flow outlet is formed on the other end side of the flow path, and
a flow inlet that is at least one of the hot-water flow inlet and the cold-water flow inlet is opened on the inner peripheral surface of the flow path, and in a flow path cross section of circular orthogonal to a central axis of the flow path, the flow inlet has an outer wall extending from the inner peripheral surface of the flow path in a direction of a tangent of the inner peripheral surface, and a central axis of the flow inlet is disposed closer to the inner peripheral surface of the flow path connected to the outer wall with respect to the central axis of the flow path.

2. The water heating device according to claim 1, wherein
each of the hot-water flow inlet and the cold-water flow inlet has the outer wall and is opened on the inner peripheral surface of the flow path, and
a positional relationship between the hot-water flow inlet and the cold-water flow inlet is that the hot-water flow inlet and the cold-water flow inlet are disposed at different positions by a predetermined angle in a circumferential direction of the inner peripheral surface of the flow path or at the same position in the circumferential direction.

3. The water heating device according to claim 2, wherein a total length of an inner diameter of the hot-water flow inlet and an inner diameter of the cold-water flow inlet is set to be equal to or less than an inner diameter of the flow path.

4. The water heating device according to claim 1, wherein the hot-water flow inlet and/or the cold-water flow inlet are disposed at angles where the central axes of the flow inlet substantially orthogonal to the central axis of the flow path.

5. The water heating device according to claim 2, wherein the hot-water flow inlet and/or the cold-water flow inlet are disposed at angles where the central axes of the flow inlet substantially orthogonal to the central axis of the flow path.

6. The water heating device according to claim 3, wherein the hot-water flow inlet and/or the cold-water flow inlet are disposed at angles where the central axes of the flow inlet substantially orthogonal to the central axis of the flow path.
